(19) United States
(12) Patent Application Publication
(10) Pub. No.: US 2026/0078619 A1
(43) Pub. Date: Mar. 19, 2026

(54) DOUBLE LOCKED SAFETY DOOR BARRIER

(71) Applicants: XIAOZHOU YANG, Langzhong (CN); XINGXING ZHANG, Laibin (CN)

(72) Inventors: XIAOZHOU YANG, Langzhong (CN); XINGXING ZHANG, Laibin (CN)

(21) Appl. No.: 19/232,799

(22) Filed: Jun. 9, 2025

(30) Foreign Application Priority Data
Sep. 18, 2024 (CN) 202422271046.9

(51) Int. Cl. E05C 1/12; E05F 1/10; E06B 9/00; E06B 9/04

(52) U.S. Cl. CPC E05C 1/12; E05F 1/1025; E06B 9/04; E06B 2009/002

(57) ABSTRACT

A double locked safety door barrier is provided, which includes a door frame and a door leaf hinged inside the door frame. A switch housing is provided on the door leaf, an upper locking tongue and a lower locking tongue are respectively provided in the switch housing and at a bottom of the door leaf. An upper locking buckle and a lower locking buckle are provided on the door frame; an upper unlocking component and a lower unlocking component are respectively provided on the switch housing. The lower unlocking component is connected to the lower locking tongue through a connector and is provided with a two-way lock structure that can only be driven to be retracted by pressing the upper unlocking component after pressing the lower unlocking component. The two-way lock structure simplifies the user's operation process and increases the safety of a locker.

### CROSS-REFERENCE TO RELATED APPLICATIONS

This application claims priority to Chinese Patent Application No. 202422271046.9, filed on Sep. 18, 2024, which is hereby incorporated by reference in its entirety.

### TECHNICAL FIELD

The present disclosure relates to the field of safety door barrier technologies, and in particular, to a double locked safety door barrier.

### BACKGROUND

A safety door barrier is a home safety device used to protect children and pets. It is generally used in isolated areas such as stairwells, kitchen entrances, balconies, etc. Its main function is to prevent children and pets from accidentally entering dangerous areas, thereby ensuring safety. Most existing safety door barriers are arranged with bidirectional opening. Thus, it easy for a user to pass through from any direction and equipped with locks that can automatically lock after the door barrier is closed. To prevent children from easily unlocking the door barrier and further enhance safety. Some door barriers adopt a dual lock design, which requires the user to simultaneously press two different buttons at different positions to unlock the upper and lower locks before opening the door barrier. This design can prevent children from easily opening the door barrier due to a single simple action, thereby greatly reducing a possibility of children unlocking on their own and effectively preventing them from accidentally entering dangerous areas. Some door barriers also use complex rotating or sliding unlocking devices, making the unlocking process not only require a certain amount of force, but also more complex operations, which is more difficult for young children and further enhances a protective effect.

Although the existing safety barriers use a dual locking mechanism to prevent children from easily unlocking, these methods can only provide effective protection for younger children. However, as children age, their observational and imitative abilities gradually increase. Older children who are tall enough to touch the unlock button on the door barrier may learn how to unlock these double locks by observing their parents'unlocking operations, and even by repeatedly experimenting or randomly pressing the button. Once children master the unlocking technique, the protective effect of the safety door barrier will be greatly reduced, and the safety hazards will increase accordingly. In such a situation, children may autonomously enter restricted areas such as kitchens, balconies, or stairwells, facing a higher risk of accidents. Although the unlocking device with complex unlocking operations is effective in preventing children from accidentally opening it, it may also bring some inconvenience to daily use. Firstly, the tedious unlocking process may cause inconvenience for the user when they urgently need to quickly pass through the door barrier, especially in scenarios that require frequent entry and exit of isolated areas such as kitchens, living rooms, etc. This repetitive and complex operation can easily make people feel tired or impatient, which may lead to the user being unwilling to keep the door barrier locked all the time and instead increase potential security risks.

Therefore, the existing safety barriers still need additional protective measures to supplement safety measures in preventing children from accidentally opening them to solve the existing problems.

### SUMMARY

The purpose of the present disclosure is to provide a double locked safety door barrier with a simple structure and convenient and fast opening.

In order to achieve the above objectives, the present disclosure adopts the following scheme: a double locked safety door barrier, including a “U” shape door frame and a door leaf hinged inside the door frame and is opened or closed back and forth, where a switch housing is provided at an upper corner of a non-hinged side of the door leaf; an upper locking tongue and a lower locking tongue are respectively provided inside the switch housing and at a bottom of the door leaf; an upper locking buckle and a lower locking buckle corresponding to the upper locking tongue and the lower locking tongue are provided on the door frame; an upper unlocking component configured to drive the upper locking tongue to be retracted from the upper locking buckle, and a lower unlocking component configured to drive the lower locking tongue to be retracted from the lower locking buckle are respectively provided on the switch housing; where the lower unlocking component is connected to the lower locking tongue through a connector; the lower unlocking component is further provided with a two-way lock structure configured to drive the upper locking tongue to be retracted by pressing the upper unlocking component after pressing the lower unlocking component. By linking the upper and lower unlocking components together, the user's operation process is simplified and increases the security of a locker. The user needs to operate the unlocking component first to further unlock the upper locking tongue. Operating the unlocking component alone cannot drive the upper locking tongue to be retracted and unlocked. This dual-operation design effectively prevents accidental opening and is particularly suitable for child safety door barriers. This structure ensures safety while also considering ease of operation. Thus, the user feels more convenient and at ease in daily use.

In some embodiments of the present disclosure, an upper locking tongue groove is provided in the switch housing, the upper locking tongue is slidably and laterally provided in the upper locking tongue groove; a front end of the upper locking tongue groove is provided with an upper locking tongue hole that allows the front end of the upper locking tongue to be extended and for the upper locking buckle to be inserted; pressing slopes are provided at a top of the upper locking tongue; an upper and a lower of the upper locking tongue groove are respectively provided with an upper button slot that penetrates a top surface of the switch housing and is communicated to the upper locking tongue groove, and a lower button slot that penetrates a bottom of the switch housing and is communicated to the upper locking tongue groove; the upper unlocking component includes a pressing plate with one end hinged to the upper button slot; a bottom of the pressing plate is provided with a push rod, and one end of the push rod abuts against the pressing slope; the lower unlocking component is movably provided in the lower button slot. By providing the upper locking tongue groove in the switch housing, and a cooperation between a lateral sliding of the upper locking tongue and the upper locking buckle, which effectively improves the stability and accuracy of the locker. By pressing the pressing plate of the upper unlocking component, the push rod abuts against the pressing slopes of the upper locking tongue for compression, and a driving structure of the upper locking tongue is retracted, making the sliding of the upper locking tongue smoother and avoiding the situation of locking tongue. The overall design of this scheme not only improves the durability of the locker but also ensures a reliable locking state of the locker after each use.

In some embodiments of the present disclosure, the two-way lock structure includes an avoidance groove provided on at least one outer wall of the upper locking tongue; an opening of the avoidance groove is extended to a tail end of the upper locking tongue; a top rod corresponding to the avoidance groove and abutting against the tail end of the upper locking tongue is provided on the lower unlocking component; when the lower unlocking component moves upward along the lower button slot, the top rod aligns with the opening of the avoidance groove, and the upper locking tongue is pushed back by the push rod, the top rod is inserted into the avoidance groove. The two-way lock structure achieves the restriction of the upper locking tongue by the lower unlocking component through the cooperation of the avoidance groove and the top rod. Only when the lower unlocking component is moved to a specific position, the top rod can be inserted into the avoidance groove, allowing the upper locking tongue to be pushed back by the pressing plate. This locking mechanism effectively reduces the possibility of children unlocking through simple attempts and also improves the overall protective performance of the locker. Especially for scenarios where children need to prevent accidental unlocking, it has a significant effect. The overall design of the two-way lock effectively increases the anti-misoperation ability of the locker, ensuring that the door barrier remains in a safe locked state even when subjected to external forces or misoperation.

In some embodiments of the present disclosure, a first reset member configured to maintain the front end of the upper locking tongue to be extended out of the upper locking tongue hole is provided between the tail end of the upper locking tongue and a tail end of the upper locking tongue groove; a second reset member that is reset again when the lower unlocking component is moved is provided between the lower unlocking component and a top of the lower button slot. An automatic reset function is achieved by providing the reset components in the upper locking tongue and lower unlocking component. This design ensures that after each operation, the locker can have the first reset member and the second reset member responsible for restoring the upper locking tongue and the lower unlocking component to their initial locked state, thereby avoiding safety hazards caused by human negligence. The collaborative work of the reset member, locking tongue, and unlocking component makes the operation of the locker smoother, and also enhances the user's sense of security and convenience in actual use.

In some embodiments of the present disclosure, a lower locking shell with an inner cavity is provided at a lower corner of the non-hinged side of the door leaf; the lower locking tongue is provided in the inner cavity of the lower locking shell; a bottom of the lower locking shell is provided with a lower locking tongue hole communicated to the inner cavity; a pull rope hole penetrates a top of the lower locking shell; the connector is a pull rope that penetrates the door leaf; one end of the pull rope passes through the pull rope hole and is fixed on the lower locking tongue, the other end of the pull rope is fixed on the lower unlocking component; a third reset member configured to maintain the lower locking tongue to be extended out of the lower locking tongue hole and for the lower locking buckle to be inserted is provided between the lower locking tongue and the top of the lower locking shell. By providing the lower locking shell at the lower corner of the non-hinged side of the door leaf and connecting the lower unlocking component to the lower locking tongue through a pull rope, an expansion-and-contraction control of the lower locking tongue is achieved. The user can unlock the upper and lower lockers with just one operation. This design not only improves the convenience of operation but also ensures the synchronization and accuracy of the locking tongue, thereby effectively enhancing the overall protective effect of the door barrier.

In some embodiments of the present disclosure, an upper rotating shaft is provided at an upper corner of the door leaf away from the switch housing; a hinge seat is provided on a column of the door frame adjacent to the upper rotating shaft; the hinge seat is provided with an upper shaft seat that is extended upward in a tubular shape and allows the upper rotating shaft to be rotatably inserted; a lower rotating shaft is provided at a lower corner of the door leaf corresponding to a lower of the upper rotating shaft; the lower rotating shaft is movably inserted into a bottom crossbeam of the door frame, a “V” shaped groove with a downward depression is provided at a top of the upper shaft seat; a triangular block having a downward protrusion and inserting into the “V” shaped groove is provided around a circumference of the upper rotating shaft. By coordinating the V-shaped groove on the top of the upper shaft seat with the triangular block on the upper rotating shaft, the door leaf can automatically reset to the closed state after opening. This design can automatically close the door leaf without additional operation, further enhancing the protective function of the door barrier, reducing the risk of human negligence causing the door barrier to not close, and improving user convenience.

In some embodiments of the present disclosure, a positioning groove that is downward recessed and allows a sharp end of the triangular block to be inserted is provided at the top of the upper shaft seat, the positioning groove and the “V” shaped groove are in a cross shape and they are distributed on a top periphery of the upper shaft seat. The design of an interlocking between the positioning groove and the triangular block allows the door leaf to stop in a fully open state when it is opened to 90 degrees relative to the door frame, without automatically closing. This facilitates the need for frequent entry in a short period of time.

In some embodiments of the present disclosure, a bottom of the hinge seat is provided with a spring groove that is coaxial with and communicated to the inner cavity of the upper shaft seat; a diameter of the spring groove is greater than a diameter of the inner cavity of the upper shaft seat; a bottom of the spring groove penetrates a bottom surface of the hinge seat; a bottom end of the upper rotating shaft is extended downward into the spring groove, and a spring base with an outer edge that closes a bottom opening of the spring groove is provided on the bottom end of the upper rotating shaft through screws; a push spring that is sleeved onto the bottom end of the upper rotating shaft is provided between the spring base and a top inner wall of the spring groove. By providing the push spring at the bottom of the upper rotating shaft, the automatic reset function of the door leaf after opening has been achieved. Based on further ensuring that the door leaf can reset by its own weight, this design also enhances the closing force and reliability of the door leaf, thereby ensuring the continuous effectiveness and stability of the door barrier after multiple uses, and preventing the door leaf from being stuck by a rotating shaft friction when closing.

In some embodiments of the present disclosure, one end of the pressing plate away from the hinged side is provided with a first hook that is clamped on an inner edge of a top opening of the upper button slot, the first hook prevents one end of the pressing plate away from the hinged side from disengaging from the upper button slot; front and rear ends of the lower unlocking component are respectively provided with a second hook that prevents the lower unlocking component from disengaging from the lower button slot. By providing the hook on the pressing plate and lower unlocking component, these components are prevented from disengaging from their slots during use. This design effectively enhances the overall firmness of the locker, ensuring long-term stable use of the door barrier, and reducing safety hazards caused by component detachment.

In some embodiments of the present disclosure, the upper locking tongue includes an upper locking tongue shell; a telescopic groove is provided in the upper locking tongue shell; a front end of the telescopic groove penetrates a front side of the upper locking tongue shell, a locking bolt that is slid back and forth in the telescopic groove is provided in the telescopic groove; a fourth reset member is provided between a tail end of the locking bolt and an inner wall of a tail end of the telescopic groove; the fourth reset member is a reset spring; an anti-detachment groove is provided at a top of the telescopic groove; a top of the locking bolt is provided with an anti-detachment clamp block that is inserted into the anti-detachment groove and moves back and forth in the anti-detachment groove; squeezing grooves are respectively provided on outer walls of left and right sides of the upper locking tongue shell, the pressing slopes are provided on a wall surface facing a rear side of the squeezing grooves, the avoidance grooves are respectively provided on left and right outer walls of the upper locking tongue shell behind the squeezing grooves; the first reset member is provided in a center of a rear wall surface of the upper locking tongue shell. The upper locking tongue is composed of the upper locking tongue shell and a retractable locking bolt provided inside the upper locking tongue shell. This dual retractable structure design can provide stronger fixing effects during locking. The internal locking bolt can extend into the upper locking buckle when locked, while the external locking tongue shell provides additional support to ensure that the door barrier is more stable in the locked state and is not easily opened by external forces. In addition, the design of automatic telescopic reset of the locking bolt can be retracted only when the door is closed normally, without the need for the entire locking tongue shell to participate in the retraction, which can make the door closing smoother.

In some embodiments of the present disclosure, the upper locking tongue includes an upper locking tongue shell, the upper locking tongue shell is provided with a telescopic groove, a front end of the telescopic groove penetrates a front side of the upper locking tongue shell; a locking bolt sleeve that is slid forward and backward in the telescopic groove is provided in the telescopic groove; the locking bolt sleeve is provided with a magnetic locking bolt, the upper locking buckle is embedded with a magnetic block configured for the magnetic locking bolt to be extended into the upper locking buckle, a tail end of the locking bolt is provided with a protrusion with a diameter greater than that of the locking bolt, the fourth reset member is provided at a head end of the locking bolt, the fourth reset member is a reset spring; a tail end of the fourth reset member abuts against a protrusion; a head end of the fourth reset member abuts against a front wall of an inner cavity of the locking bolt sleeve; the anti-detachment groove is provided at a top of the telescopic groove, and the anti-detachment clamp block is inserted into the anti-detachment groove and move back and forth in the anti-detachment groove is provided at a top of the locking bolt sleeve; the pressing slopes are provided on left and right sides of the upper locking tongue shell; the first reset member abuts against a center of a rear wall of the upper locking tongue shell. This technical solution sleeves the reset spring at the end of the locking bolt head, so that the locking bolt always retracts into the locking tongue groove when the door leaf is opened. After the door leaf is closed, in this scheme, a magnetic attraction of the magnetic block inside the locking buckle drives the locking bolt to insert into the corresponding upper locking buckle, thereby achieving a locking of the door leaf. On the one hand, this design can effectively eliminate noise when the door leaf is closed. Besides that, when the user enters and exits the door, even if the control of the door leaf is released, the door leaf can smoothly complete the locking action of inserting the upper locking buckle, further ensuring the effectiveness of the door barrier protection.

In summary, the beneficial effect of the present disclosure compared to the prior art is that it achieves a linkage mechanism between the upper and lower unlocking components through the two-way lock structure design, thereby effectively increasing the complexity of unlocking operations. The user must first press the lower unlocking component located below the switch housing before operating the upper unlocking component, which greatly improves the effect of preventing children from accidentally unlocking. For young children with limited observation abilities, it is difficult to complete two steps simultaneously by simply pressing randomly, greatly reducing their chances of unlocking successfully. Compared to traditional single locking methods, this dual locking mechanism is more secure and can effectively prevent children from accidentally entering dangerous areas, thereby ensuring their safety.

On this basis, the present disclosure achieves the automatic closing function of the door leaf through the coordinated design of the ‘V’-shaped groove and triangular block at a hinged position of the door leaf. When the user gently pushes open the door leaf, it can automatically close at a certain angle, which not only reduces the complexity of manual operation, but also prevents safety hazards caused by forgetting to close the door leaf. The interlocking design between the positioning groove and the triangular block ensures that the door leaf can maintain a stable open state when fully opened to 90 degrees, thus meeting the user's need for frequent entry and exit in a short period of time. This ensures both safety and convenience for daily use.

In addition, the dual telescopic design of the upper locking tongue provides higher strength and safety for the locker. During use, the locking tongue can flexibly extend and retract according to actual needs, thereby achieving a more stable locking effect. At the same time, this design also reduces the wear of the locking tongue, avoids damage caused by frequent use, and extends the service life of the product.

Finally, by using magnetic attractions to close the locking bolt, the noise generated when closing the door barrier can be effectively reduced, and the locking tongue of the door barrier can be more effectively ensured to complete the locking action. The use of the door barrier is safer, and the door lock failure rate will be lower.

### BRIEF DESCRIPTION OF DRAWINGS

FIG. 1 is a perspective view of a door leaf being closed of the present disclosure.

FIG. 2 is a first perspective view of the door leaf after opened of the present disclosure.

FIG. 3 is an enlarged view of point A in FIG. 2.

FIG. 4 is a second perspective view of the door leaf after opened and an enlarged view of an internal structure of a switch housing of the present disclosure.

FIG. 5 is a first sectional view of the present disclosure, as well as an enlarged view of a partial area in the figure.

FIG. 6 is a second cross-sectional view of the present disclosure, as well as an enlarged view of a partial area in the figure.

FIG. 7 is an enlarged view of point B in FIG. 6.

FIG. 8 is a third cross-sectional view of the present disclosure, as well as an enlarged view of a partial area in the figure.

FIG. 9 is an exploded view of the present disclosure, as well as an enlarged view of a partial area in the figure.

FIG. 10 is an enlarged view of point C in FIG. 9.

FIG. 11 is an enlarged view of point D in FIG. 9.

FIG. 12 is a second exploded view of the present disclosure, as well as an enlarged view of a partial area in the figure.

FIG. 13 is an enlarged view of point E in FIG. 9.

FIG. 14 is a sectional view of the present disclosure after decomposition, as well as an enlarged view of a partial area in the figure.

FIG. 15 is a first cross-sectional structural view in an embodiment of a locking bolt in the present disclosure, as well as an enlarged view of a partial area in the figure.

FIG. 16 is a second cross-sectional structural view in an embodiment of the locking bolt in the present disclosure, as well as an enlarged view of a partial area in the figure.

FIG. 17 is an exploded structural view in an embodiment of the locking bolt of the present disclosure, as well as an enlarged view of a partial area in the figure.

Numeral reference: 1—door frame; 2—door leaf; 3—switch housing; 4—upper locking tongue; 5—lower locking tongue; 6—upper unlocking component; 7—lower unlocking component; 8—two-way lock structure; 11—upper locking buckle; 12—lower locking buckle; 13—magnetic block; 20—upper shaft seat; 21—upper rotating shaft; 22—hinge seat; 23—“V” shaped groove; 24—triangular block; 25—lower rotating shaft; 26—spring groove; 27—spring base; 28—push spring; 29—positioning groove; 30—upper locking tongue hole; 31—locking tongue groove; 32—upper button slot; 33—lower button slot; 34—strip-shaped slot; 40—upper locking tongue shell; 41—pressing slope; 42—avoidance groove; 43—first reset member; 44—telescopic groove; 45—locking bolt; 45a—locking bolt sleeve; 45b—protrusion; 46—fourth reset member; 47—anti-detachment groove; 48—anti-detachment clamp block; 49—squeezing groove; 50—connector; 51—lower locking shell; 52—lower locking tongue hole; 53—pull rope hole; 54—third reset member; 60—pressing plate; 61—push rod; 62—first hook; 71—top rod; 72—second reset member; 73—second hook.

### DESCRIPTION OF EMBODIMENTS

The following specific description provides various embodiments or examples for implementing the present disclosure. Of course, these are only embodiments or examples and are not intended to be limiting. Besides that, repeated numbering may be used in different embodiments, such as repeated numbers and/or letters. These repetitions are intended to provide a simple and clear description of the present disclosure, and do not represent any specific relationship between the different embodiments and/or structures discussed.

Besides that, spatial terms such as “below”, “lower”, “from inside to outside”, “above”, “up”, and similar terms may be used to describe a relationship between one element or feature in the figure and another one. These spatial terms include different orientations of the device in use or operation, as well as the orientation described in the figure. The device may be rotated 90 degrees or other directions in different directions, and the spatial related adjectives used therein may also be interpreted accordingly. Therefore, they cannot be understood as limitations on the present disclosure. Terms “first” and “second” are only used for a descriptive purpose and cannot be understood as indicating or implying relative importance or implying the number of technical features indicated. Thus, features limited to “first” and “second” may explicitly or implicitly include one or more of these features.

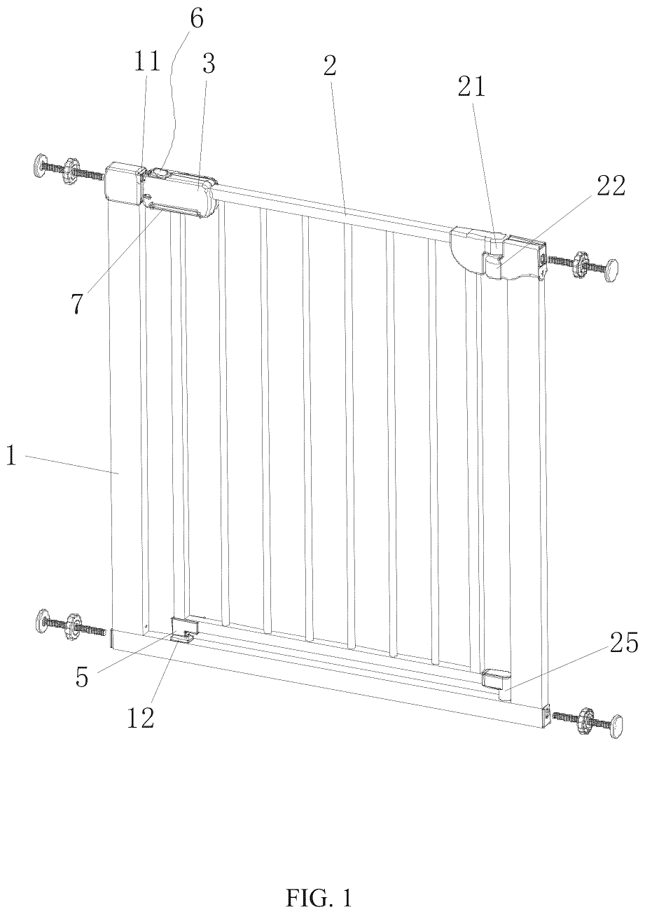

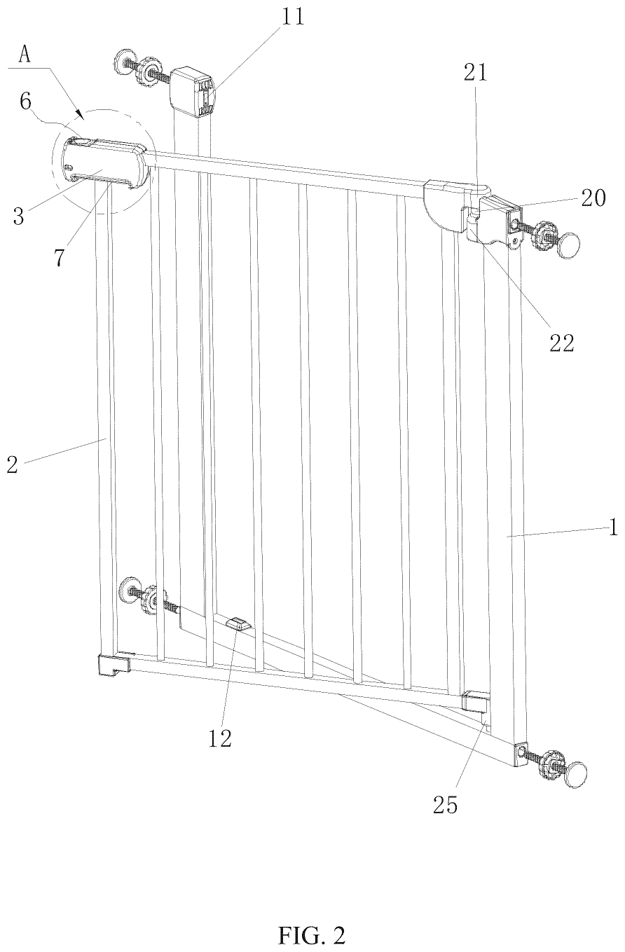

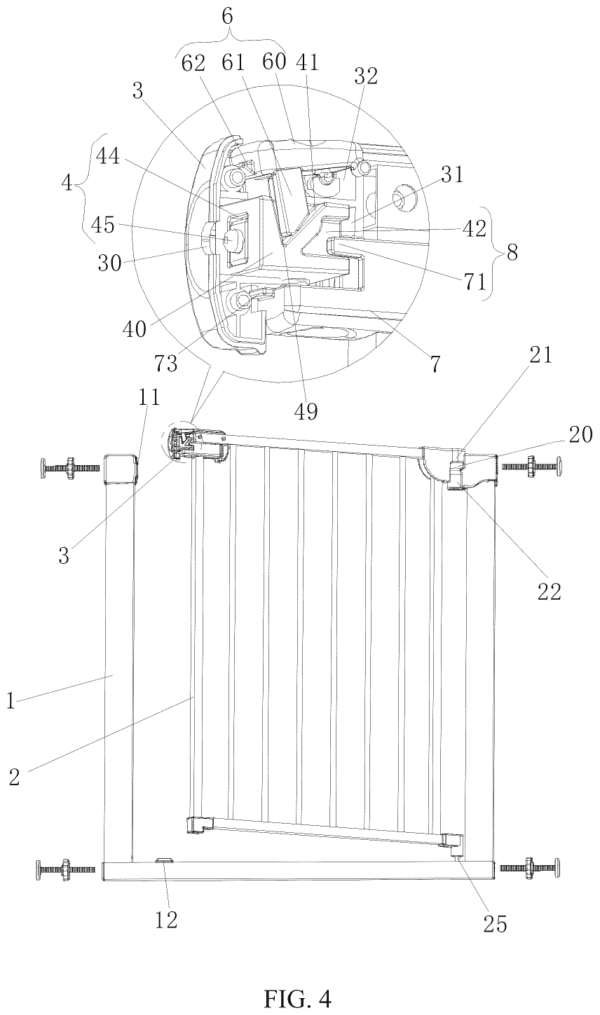

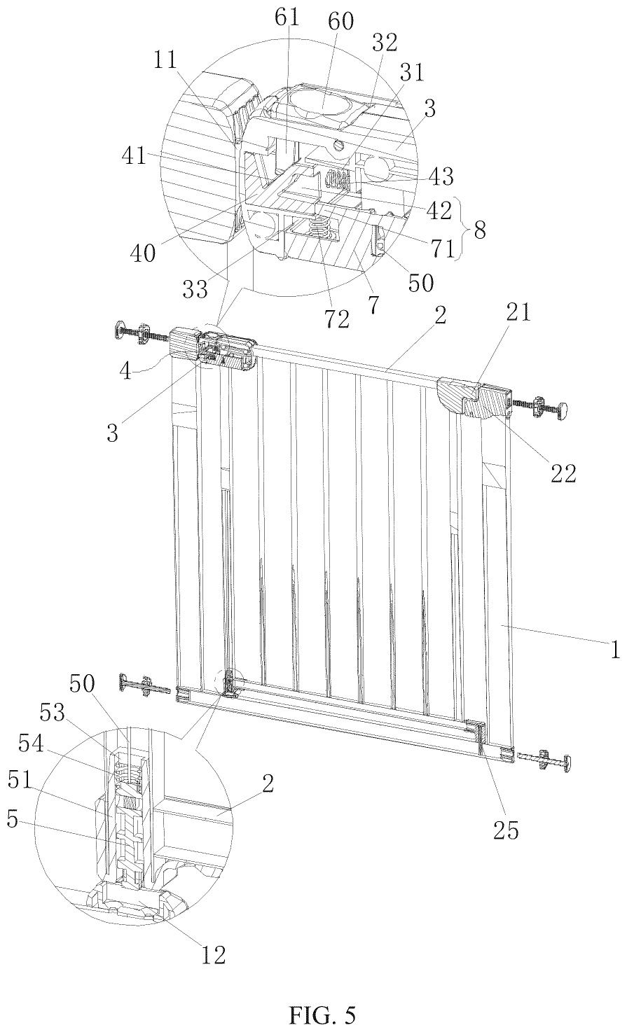

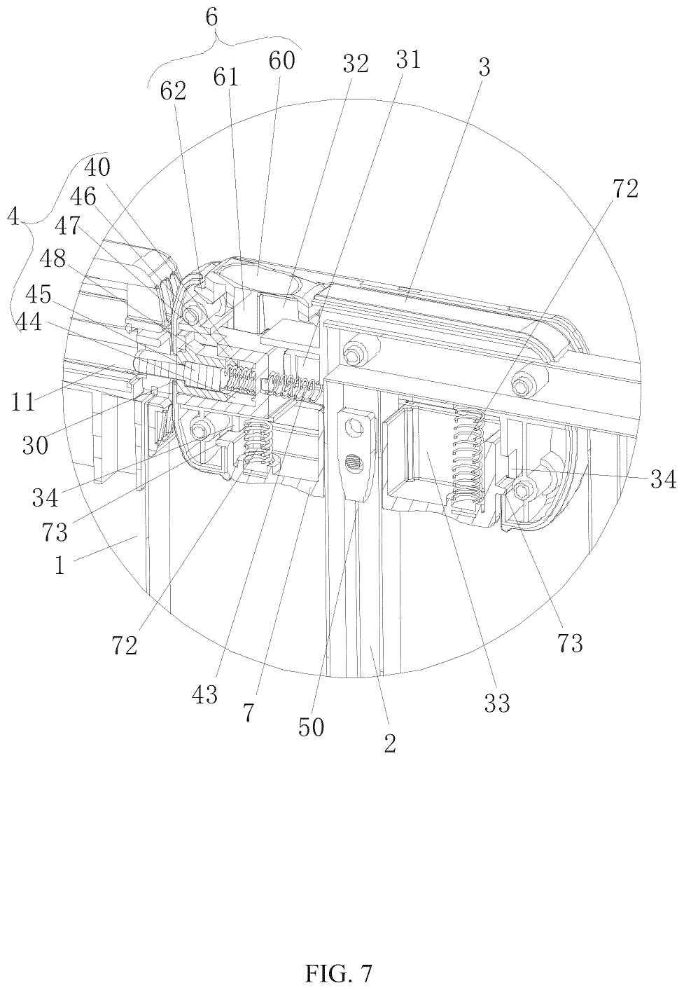

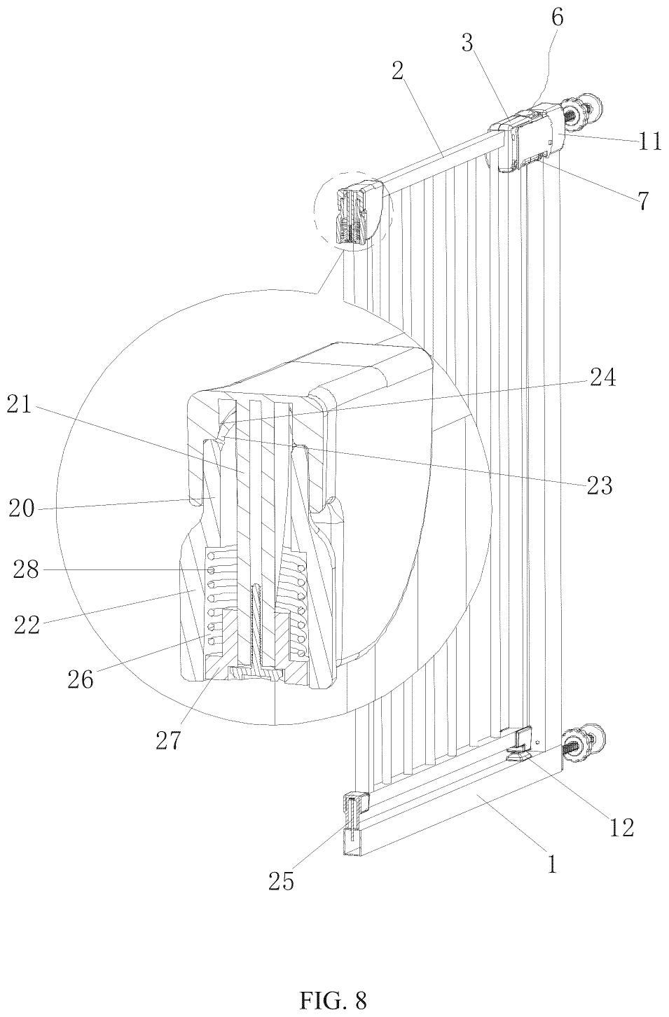

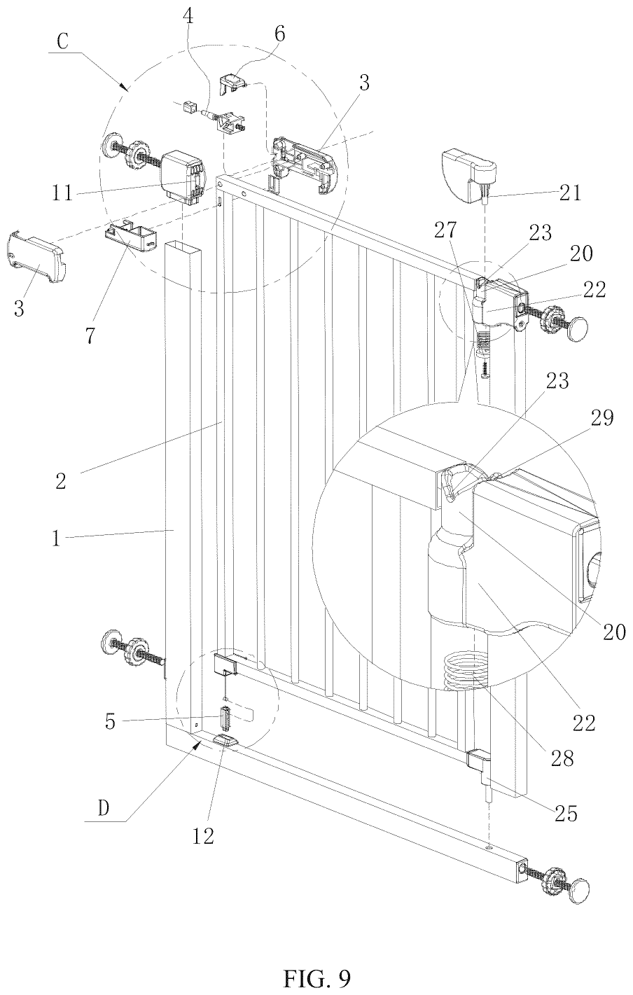

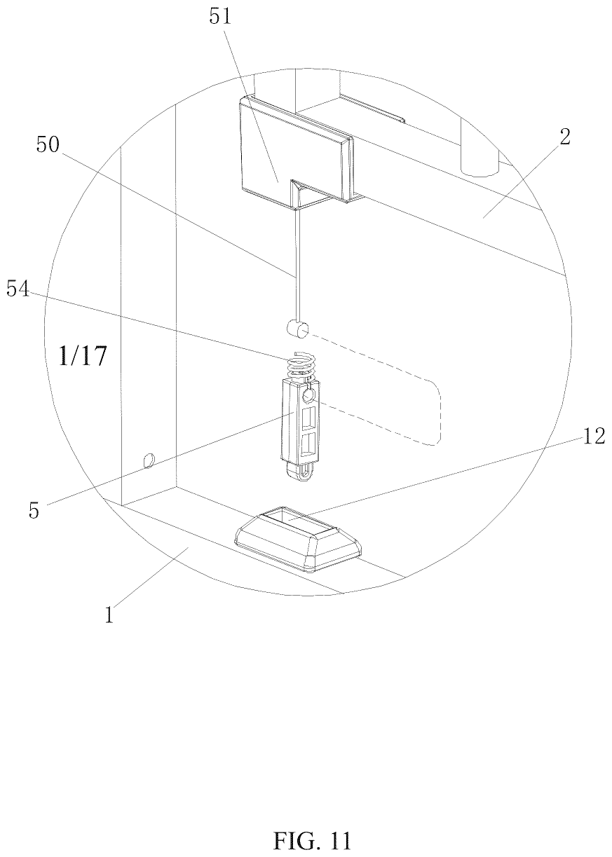

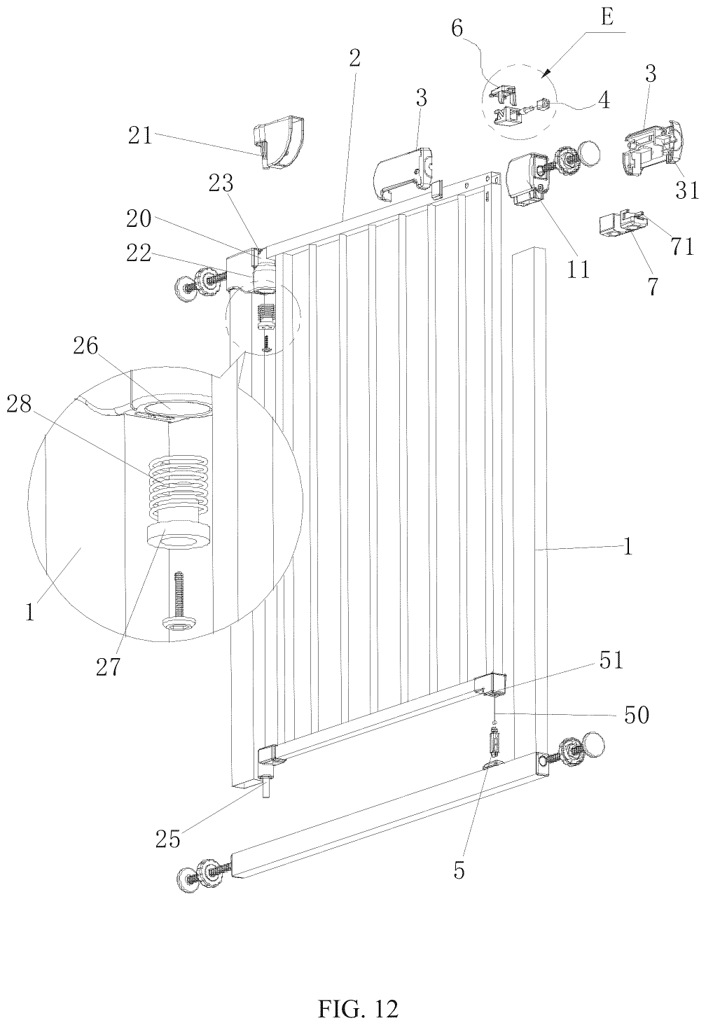

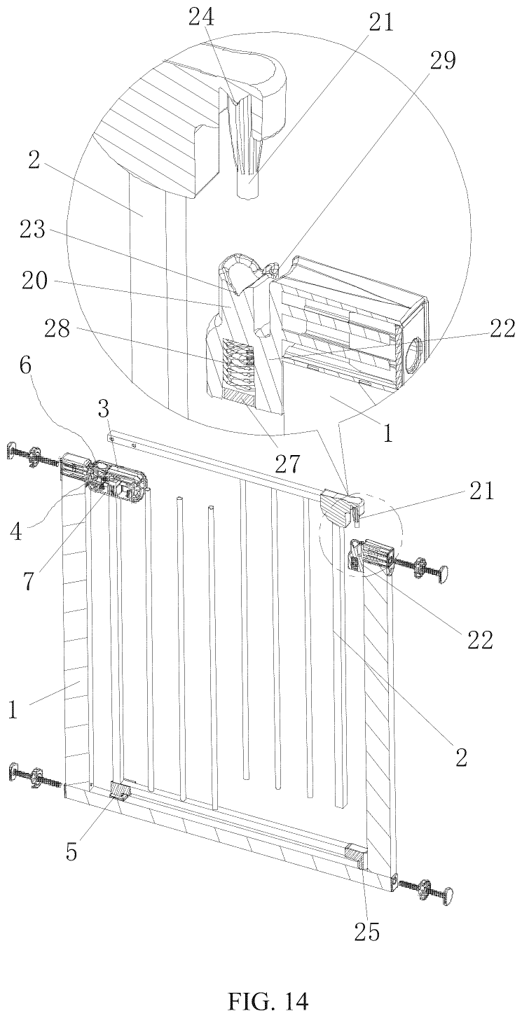

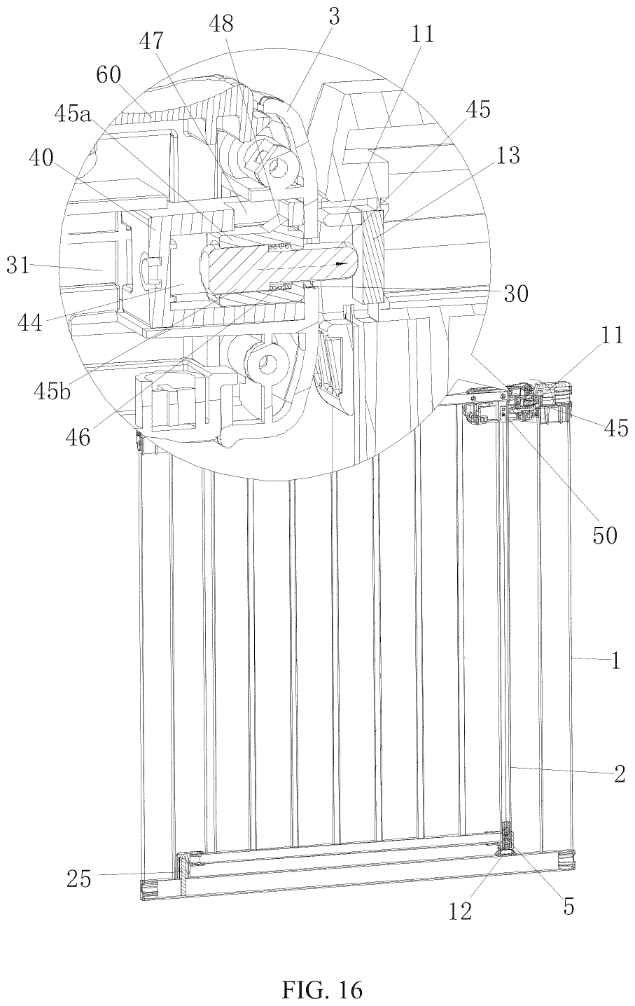

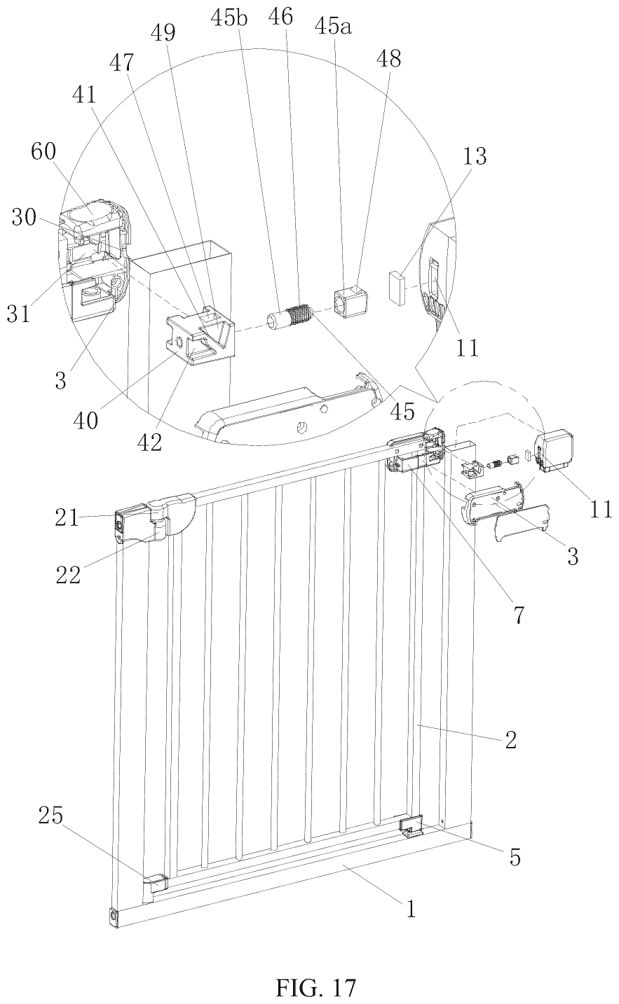

The present disclosure is further described with reference to the accompanying drawings and specific implementation modes. A double locking safety door frame, as shown in FIGS. 1 to 17, includes a “U” shaped door frame 1. The door frame 1 is composed of two vertically spaced columns and a crossbeam connected to bottoms of the two columns. The door frame 1 is fixed to the door frame or a wall by installing bolts at four corners of the two columns, which is basically the same as a fixing method in the prior art. The door frame 1 is hinged with a door leaf 2 that can be opened or closed forward and backward. A switch housing 3 is provided at an upper corner of a non-hinged side of the door leaf 2. An upper locking tongue 4 and a lower locking tongue 5 are respectively extendable and retractably provided inside the switch housing 3 and at a bottom of the door leaf 2. An upper locking buckle 11 and a lower locking buckle 12 are respectively provided on the door frame 1, which correspond to the upper locking tongue 4 and the lower locking tongue 5. An upper unlocking component 6 that can drive the upper locking tongue 4 to be retracted from the upper locking buckle 11 and a lower unlocking component 7 that can drive the lower locking tongue 5 to be retracted from the lower locking buckle 12 are respectively provided on the switch housing 3. The upper locking tongue 4 and the lower locking tongue 5 are arranged to be extendable and can be matched with the upper locking buckle 11 and the lower locking buckle 12 on the door frame 1, thereby ensuring a locking of the door leaf 2. When a user needs to unlock, he must operate through the upper unlocking component 6 and the lower unlocking component 7. The lower unlocking component 7 is connected to the lower locking tongue 5 through a connector 50 and is provided with a two-way lock structure 8 that can drive the upper locking tongue 4 to be retracted by pressing the upper unlocking component 6 after pressing the lower unlocking component 7. The advantage of this design is that it increases the complexity of unlocking and prevents children from accidentally unlocking. The user must first press the lower unlocking component located below the switch housing before operating the upper unlocking component, thereby greatly improving the effect of preventing children from accidentally unlocking. For young children with limited observation ability, it is difficult to complete two steps at the same time, thereby greatly reducing their chances of unlocking successfully.

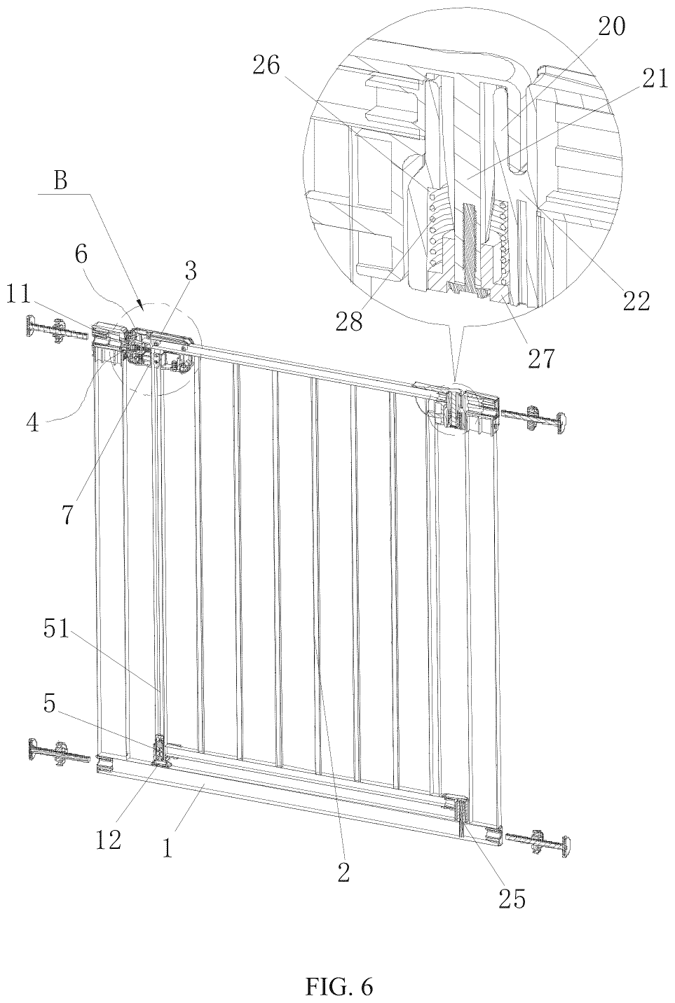

Besides that, as shown in FIGS. 6, 8, 9, 12, and 14, an upper rotating shaft 21 is provided at an upper corner of the door leaf 2 away from the switch housing 3, and a hinge seat 22 is provided on a column of the door frame 1 adjacent to the upper rotating shaft 21. The upper rotating shaft cooperates with the hinge seat 22 on the adjacent door frame column. The hinge seat 22 is provided with an upper shaft seat 20 that is extended upward in a tubular shape and can allow the upper rotating shaft 21 to be rotatably inserted. A lower rotating shaft 25 is provided at a lower corner below the upper rotating shaft 21 corresponding to the door leaf 2, and the lower rotating shaft 25 is movably inserted into a bottom crossbeam of the door frame 1. On a top of the upper shaft seat 20, there is a “V”-shaped groove 23 in a downward concave shape. Around a circumference of the upper rotating shaft 21, there is a triangular block 24 with a downward protrusion that can be inserted into the corresponding “V”-shaped groove 23. The triangular block 24 can be inserted into the corresponding “V”-shaped groove 23. When the door leaf 2 is opened no more than 90 degrees, an inclined edge of the triangular block 24 and an inclined edge of the “V”-shaped groove 23 are pressed against each other, thereby achieving an automatic closing function of the door leaf 2. At a top of the upper shaft seat 20, there is a downward concave positioning groove 29 that can allow a shape end of the triangular block 24 to be embedded. The positioning groove 29 intersects with the “V”-shaped groove 23 in a cross shape and they are distributed on a top periphery of the upper shaft seat 20. When the door leaf is opened to 90 degrees, the triangular block 24 and the positioning groove 29 are engaged with each other, thereby ensuring that the door leaf 2 can automatically fix and maintain a fully open state when opened to 90 degrees, facilitating a frequent entry and exit in a short period of time. In order to ensure a smooth closure of the door leaf 2, a bottom of the hinge seat 22 is provided with a spring groove 26 that is coaxial with and communicated to an inner cavity of the upper shaft seat 20. A diameter of the spring groove 26 is greater than that of the inner cavity of the upper shaft seat 20, and a bottom of the spring groove 26 penetrates a bottom surface of the hinge seat 22. A bottom end of the upper rotating shaft 21 is extended downward into the spring groove 26, and a spring base 27 is provided at a bottom end of the upper rotating shaft 21 through screws. The spring base 27 is disc-shaped, and its outer edge can close a bottom opening of the spring groove 26. A push spring 28 that can be sleeved on a bottom end of the upper rotating shaft 21 is provided between the spring base 27 and an inner wall of a top of the spring groove 26. The push spring 28 provides additional closing force, thereby ensuring a smoother and more stable closing of the door leaf 2.

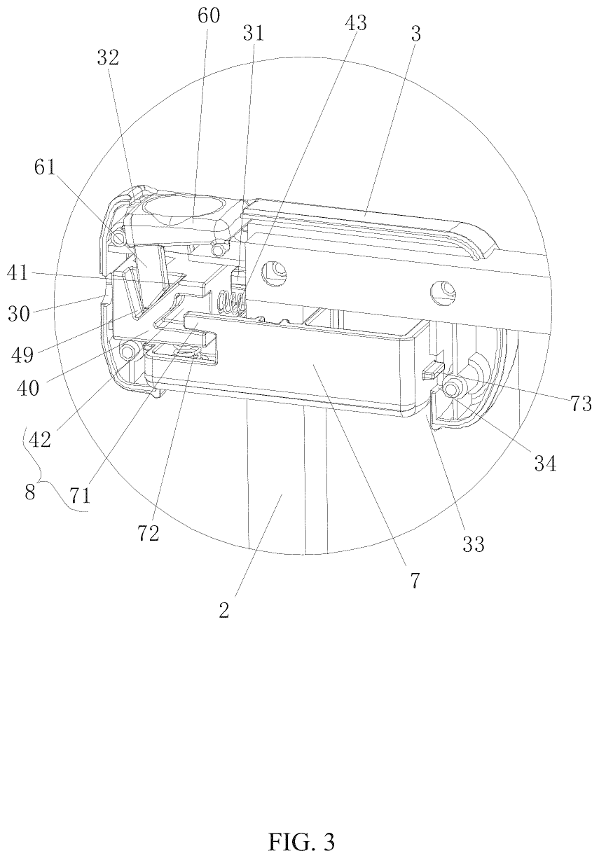

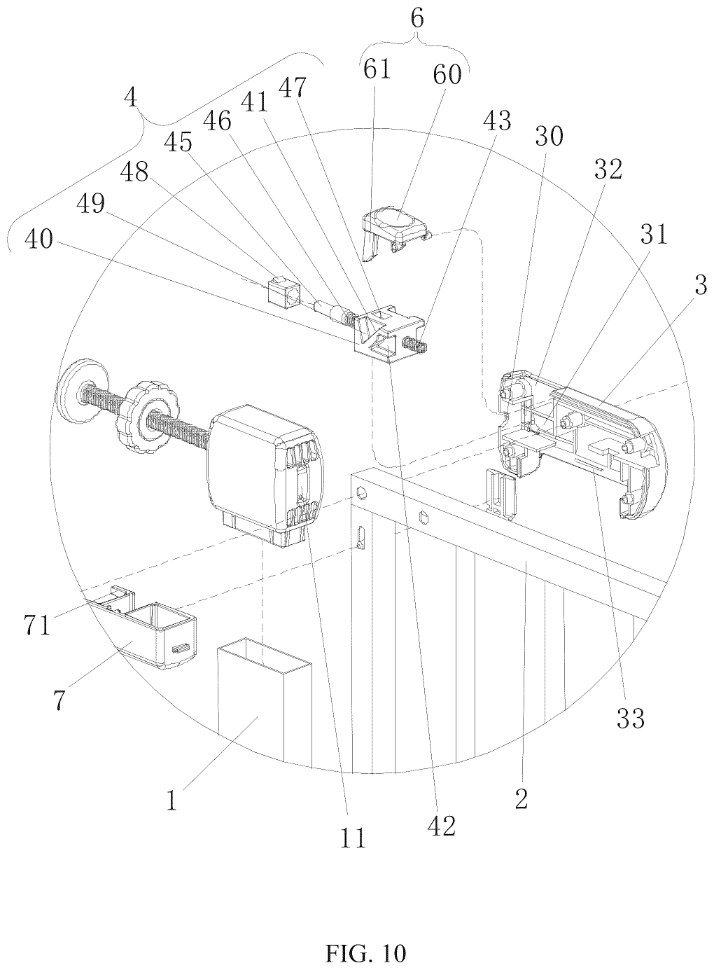

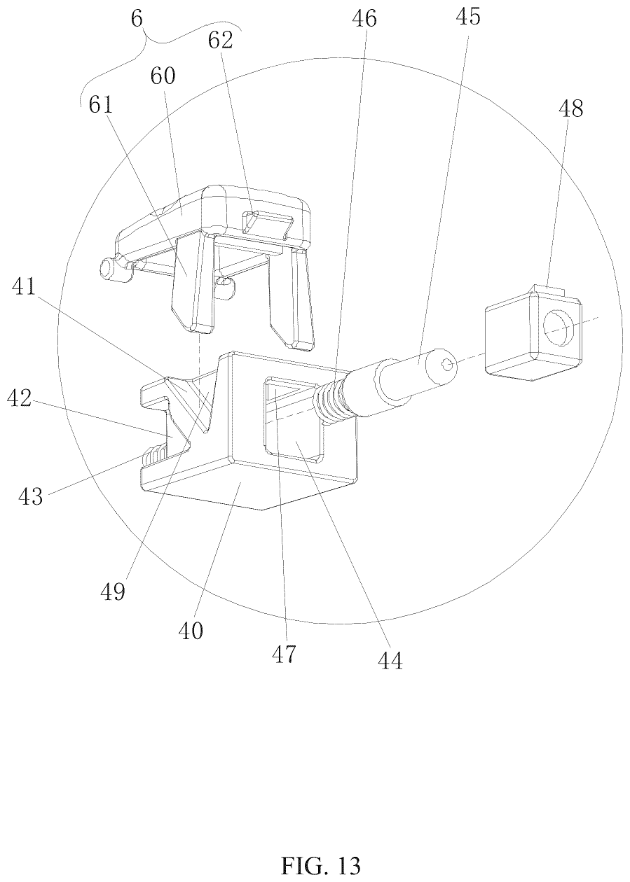

Besides that, as shown in FIGS. 3 to 7, as well as FIGS. 10 and 13, a locking tongue groove 31 is provided in the switch housing 3, and the upper locking tongue 4 is horizontally slidably provided in the upper locking tongue groove 31. A front end of the upper locking tongue groove 31 is provided with an upper locking tongue hole 30 that can allow a front end of the upper locking tongue 4 to extend and be inserted into the upper locking buckle 11. A pressing slopes 41 are provided at a top of the upper locking tongue 4. An upper button slot 32 that can penetrate a top surface of the switch housing 3 and be communicated to the upper locking tongue groove 31 below and a lower button slot 33 that can penetrate a bottom of the switch housing 3 and be communicated to the upper locking tongue groove 31 are provided in the switch housing 3 at an upper and a lower of the locking tongue groove 31. The upper unlocking component 6 includes a pressing plate 60 with one end hinged in the upper button slot 32. A push rod 61 is extended downward from a bottom of the pressing plate 60, one end of the push rod 61 is designed to slide against the pressing slopes 41 that can cooperate with it. When the upper unlocking component is pressed, a bottom end of the push rod 61 comes into contact with the pressing slopes 41, the upper locking tongue is pushed back. In order to prevent one end of the pressing plate 60 away from the hinged side from detaching from the upper button slot 32, one end of the pressing plate 60 away from the hinged side is provided with a first hook 62 that can be clamped on an inner edge of a top opening of the upper button slot 32. A tail end of the upper locking tongue 4 is pressed against a tail end of the upper locking tongue groove 31 through a first reset member 43, thereby keeping a front end of the upper locking tongue 4 protruding out of the upper locking tongue hole 30, and ensuring that the locking tongue can be reset in a timely manner after unlocking. The lower unlocking component 7 is provided in the lower button slot 33. Front and rear ends of the lower unlocking component 7 are respectively provided with a second hook 73 that can prevent the lower unlocking component 7 from disengaging from the lower button slot 33. Inner walls of front and rear sides of the lower button slot 33 are respectively provided with vertical strip-shaped slot 34. The two second hooks 73 are respectively clamped in the strip-shaped slot 34 and can move up and down synchronously with an up-and-down movement of the lower unlocking component 7 and move up and down along the strip-shaped slot 34.

In an implementation mode, the upper locking tongue 4 includes an upper locking tongue shell 40, and the upper locking tongue shell 40 is provided with a telescopic groove 44. A front end of the telescopic groove 44 penetrates a front side of the upper locking tongue shell 40, and a locking bolt 45 that can slide forward and backward in the telescopic groove 44 is provided in the telescopic groove 44. A fourth reset member 46 is provided between a tail end of the locking bolt 45 and an inner wall of a tail end of the telescopic groove 44. A front end of the locking bolt 45 is in a shape of a round head. When the door leaf 2 is closed, left and right sides of the upper locking buckle 11 that are in contact with the locking bolt 45 are inclined, so that at the moment when the locking bolt 45 collides and contacts the upper locking buckle 11, the locking bolt 45 can be pushed forward, return to the telescopic groove 44. In order to prevent the locking bolt 45 from detaching and falling out of the telescopic groove 44, an anti-detachment groove 47 is provided at a top of the telescopic groove 44, and an anti-detachment clamp block 48 that can be inserted into the anti-detachment groove 47 and move back and forth in the anti-detachment groove 47 is provided at a top of the locking bolt 45. Squeezing grooves 49 are respectively provided on outer walls of left and right sides of the upper locking tongue shell 40, and the pressing slopes 41 are provided on a wall facing a rear side of the squeezing grooves 49. The first reset member 43 is provided in a center of a rear wall of the upper locking tongue shell 40.

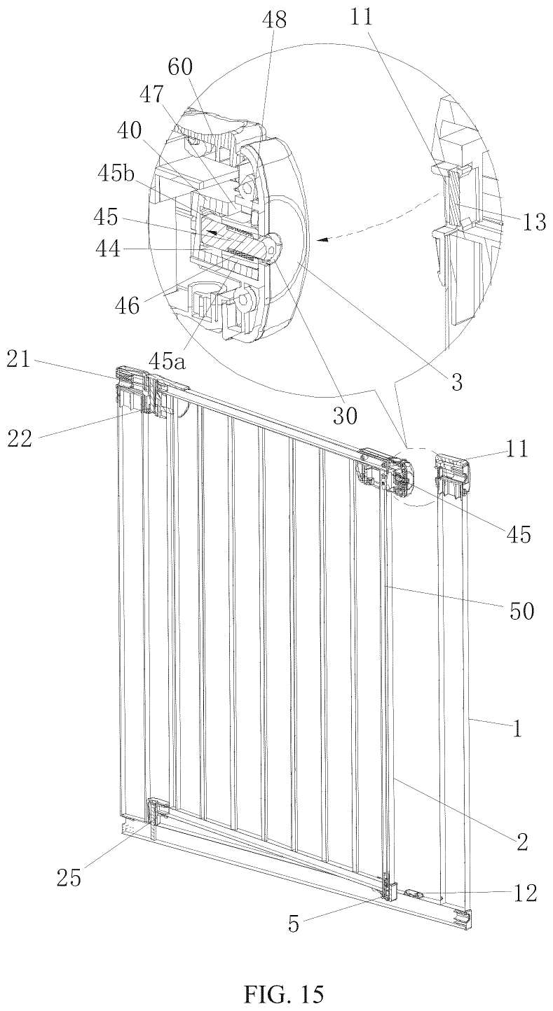

It should be noted that the locking bolt 45 in this embodiment first retracts and then inserts into the upper locking buckle 11 so as to complete a locking when the door leaf 2 is closed. This is usually achieved by a collision force generated by an instantaneous closure of the door leaf 2, causing the inclined surface of the locking bolt 45 and one side of the upper locking buckle 11 to press against each other, causing the locking bolt 45 to retract, and then relying on the spring to pop out and insert the corresponding upper locking buckle 11. But this method has the following drawbacks: firstly, there is a loud noise when closing the door leaf 2. If the closing force of door leaf 2 is too strong, the locking bolt 45 may instantly completely pass over the upper locking buckle 11, causing the door leaf 2 to fail to lock and the door barrier protection function to be lost, which will cause a safety hazard. Therefore, in an implementation mode, as shown in FIGS. 15 to 17, the upper locking tongue 4 includes an upper locking tongue shell 40, and the upper locking tongue shell 40 is provided with the telescopic groove 44 inside. A front end of the telescopic groove 44 penetrates a front side of the upper locking tongue shell 40, and a locking bolt sleeve 45a that can slide back and forth in the telescopic groove 44 is provided inside the telescopic groove 44. A magnetic locking bolt 45 is provided in a center of the locking bolt sleeve 45a, and a magnetic block 13 that can magnetically attract the locking bolt 45 and extend into the upper locking buckle 11 is embedded in the upper locking buckle 11. A tail end of the locking bolt 45 is provided with a protrusion 456 with a diameter greater than that of the locking bolt 45. A head end of the locking bolt 45 is sleeved with a fourth reset member 46, and the fourth reset member 46 is a reset spring. A tail end of the fourth reset member 46 abuts against the protrusion 45b, and a head end of the fourth reset member 46 abuts against an inner cavity wall of the locking bolt sleeve 45a. An anti-detachment groove 47 is provided at a top of the telescopic groove 44, and an anti-detachment clamp block 48 that can be inserted into the anti-detachment groove 47 and move back and forth in the anti-detachment groove 47 is provided at a top of the locking bolt sleeve 45a. The pressing slopes 41 are provided on left and right sides of the upper locking tongue shell 40, and the first reset member 43 abuts against a center of a wall surface of the upper locking tongue shell 40. By a magnetic attraction of the magnetic block 13 inside the upper locking buckle 11, when the door leaf 2 is closed, the locking bolt 45 is driven to be inserted into the corresponding upper locking buckle 11 to achieve a locking of the door leaf 2. On the one hand, this design can effectively eliminate the noise when the door leaf 2 is closed; on the other hand, when the user enters and exits the door, even if the control of the door leaf 2 is released, the door leaf 2 can smoothly complete a locking action of inserting the locking bolt 45 into the upper locking buckle 11.

It should be noted that the two-way lock structure 8 includes an avoidance groove 42 provided on at least one outer wall of the upper locking tongue 4. In this embodiment, the avoidance groove 42 is respectively provided on left and right outer walls of the upper locking tongue shell 40 behind the squeezing grooves 49. An opening of the avoidance groove 42 is extended backwards to a tail end of the upper locking tongue shell 40. A top rod 71 corresponding to the avoidance groove 42 and able to be abutted against the tail end of the upper locking tongue 4 is provided on the lower unlocking component 7. In an initial state, the top rod 71 abuts against the tail end of the upper locking tongue shell 40 below an opening of the avoidance groove 42. At this time, because the tail end of the upper locking tongue shell 40 is pressed and pressed by the top rod 71. The pressing plate 60 cannot cause the upper locking tongue shell 40 to be back Therefore, only when the lower unlocking component 7 moves upward along the lower button slot 33 and aligns the top rod 71 with the opening of the avoidance groove 42, the upper locking tongue 4 can be pushed back by the push rod 61 and the top rod 71 be inserted into the avoidance groove 42, so that the upper locking tongue shell 40 can be smoothly retreated under an action of the push rod 61, and at the same time, the locking bolt 45 can be pulled out from a groove of the upper locking buckle 11 to achieve unlocking. A second reset member 72 is provided between the lower unlocking component 7 and a top of the lower button slot 33, which can reset when the lower unlocking component 7 is moved up and then moved down again, thereby ensuring that an initial state can be restored in a timely manner after the unlocking operation is completed.

In addition, a lower locking shell 51 with an internal cavity is provided at a lower corner of the non-hinged side of the door leaf 2. The lower locking tongue 5 is extendable and provided in an inner cavity of the lower locking shell 51. A bottom of the lower locking shell 51 is provided with a lower locking tongue hole 52 that is communicated to the inner cavity. A pull rope hole 53 penetrates a top of the lower locking shell 51. The connector 50 is a pull rope that passes through the door leaf 2. One end of the pull rope passes through the pull rope hole 53 and is fixed to the lower locking tongue 5, and the other end of the pull rope is fixed to the lower unlocking component 7. Between the lower locking tongue 5 and the top of the lower locking shell 51, there is a third reset member 54 in an inner cavity that can maintain the lower locking tongue 5 to be extended from the lower locking tongue hole 52 and inserted into the corresponding lower locking buckle 12 below. By connecting the rope to the lower unlocking component 7, when unlocking, the user can press the lower unlocking component 7 to pull and retract the lower locking tongue 5, thereby completing the unlocking operation of the lower locking tongue 5. When the door leaf 2 is closed, in order to allow the lower locking tongue 5 to smoothly insert into the lower locking buckle 12 when it collides with the lower locking buckle 12, front and rear corners of the bottom of the lower locking tongue 5 are rounded, and a surface where the lower locking buckle 12 contacts the lower locking tongue 5 is a slope.

In an implementation mode, a spring is used as examples for the first reset member 43, the second reset member 72, and the third reset member 54.

The above displays and describes the basic principles and main features of the present disclosure, as well as the advantages of the present disclosure. Those skilled in the art should understand that the present disclosure is not limited by the above embodiments. The above embodiments and the description in the specification only illustrate the principles of the present disclosure. Without departing from the spirit and scope of the present disclosure, there will be various changes and improvements to the present disclosure, which fall within the scope of the claimed protection of the present disclosure. The protection scope required by the present disclosure is defined by the attached claims and their equivalents.

What is claimed is:

1. A double locked safety door barrier, comprising a “U” shape door frame and a door leaf hinged inside the door frame and is opened or closed back and forth,
wherein a switch housing is provided at an upper corner of a non-hinged side of the door leaf;
an upper locking tongue and a lower locking tongue are respectively provided inside the switch housing and at a bottom of the door leaf,
an upper locking buckle and a lower locking buckle corresponding to the upper locking tongue and the lower locking tongue are provided on the door frame,
an upper unlocking component configured to drive the upper locking tongue to be retracted from the upper locking buckle, and a lower unlocking component configured to drive the lower locking tongue to be retracted from the lower locking buckle are respectively provided on the switch housing,
wherein the lower unlocking component is connected to the lower locking tongue through a connector;
the lower unlocking component is further provided with a two-way lock structure configured to drive the upper locking tongue to be retracted by pressing the upper unlocking component after pressing the lower unlocking component.

2. The double locked safety door barrier according to claim 1, wherein an upper locking tongue groove is provided in the switch housing,
the upper locking tongue is slidably and laterally provided in the upper locking tongue groove;
a front end of the upper locking tongue groove is provided with an upper locking tongue hole that allows the front end of the upper locking tongue to be extended and for the upper locking buckle to be inserted;
pressing slopes are provided at a top of the upper locking tongue;
an upper and a lower of the upper locking tongue groove are respectively provided with an upper button slot that penetrates a top surface of the switch housing and is communicated to the upper locking tongue groove, and a lower button slot that penetrates a bottom of the switch housing and is communicated to the upper locking tongue groove;
the upper unlocking component comprises a pressing plate with one end hinged to the upper button slot;
a bottom of the pressing plate is provided with a push rod, and one end of the push rod abuts against the pressing slope;
the lower unlocking component is movably provided in the lower button slot.

3. The double locked safety door barrier according to claim 2, wherein the two-way lock structure comprises an avoidance groove provided on at least one outer wall of the upper locking tongue,
an opening of the avoidance groove is extended to a tail end of the upper locking tongue,
a top rod corresponding to the avoidance groove and abutting against the tail end of the upper locking tongue is provided on the lower unlocking component;
when the lower unlocking component moves upward along the lower button slot, the top rod aligns with the opening of the avoidance groove, and the upper locking tongue is pushed back by the push rod, the top rod is inserted into the avoidance groove.

4. The double locked safety door barrier according to claim 3, wherein a first reset member configured to maintain the front end of the upper locking tongue to be extended out of the upper locking tongue hole is provided between the tail end of the upper locking tongue and a tail end of the upper locking tongue groove;
a second reset member that is reset again when the lower unlocking component is moved is provided between the lower unlocking component and a top of the lower button slot.

5. The double locked safety door barrier according to claim 4, wherein a lower locking shell with an inner cavity is provided at a lower corner of the non-hinged side of the door leaf;
the lower locking tongue is provided in the inner cavity of the lower locking shell;
a bottom of the lower locking shell is provided with a lower locking tongue hole communicated to the inner cavity;
a pull rope hole penetrates a top of the lower locking shell;
the connector is a pull rope that penetrates the door leaf;
one end of the pull rope passes through the pull rope hole and is fixed on the lower locking tongue, the other end of the pull rope is fixed on the lower unlocking component,
a third reset member configured to maintain the lower locking tongue to be extended out of the lower locking tongue hole and for the lower locking buckle to be inserted is provided between the lower locking tongue and the top of the lower locking shell.

6. The double locked safety door barrier according to claim 1, wherein an upper rotating shaft is provided at an upper corner of the door leaf away from the switch housing;
a hinge seat is provided on a column of the door frame adjacent to the upper rotating shaft;
the hinge seat is provided with an upper shaft seat that is extended upward in a tubular shape and allows the upper rotating shaft to be rotatably inserted;
a lower rotating shaft is provided at a lower corner of the door leaf corresponding to a lower of the upper rotating shaft;
the lower rotating shaft is movably inserted into a bottom crossbeam of the door frame,
a “V”-shaped groove with a downward depression is provided at a top of the upper shaft seat;
a triangular block having a downward protrusion and inserting into the “V”-shaped groove is provided around a circumference of the upper rotating shaft.

7. The double locked safety door barrier according to claim 6, wherein a positioning groove that is downward recessed and allows a sharp end of the triangular block to be inserted is provided at the top of the upper shaft seat,
the positioning groove and the “V”-shaped groove are in a cross shape and they are distributed on a top periphery of the upper shaft seat.

8. The double locked safety door barrier according to claim 6, wherein a bottom of the hinge seat is provided with a spring groove that is coaxial with and communicated to the inner cavity of the upper shaft seat;
a diameter of the spring groove is greater than a diameter of the inner cavity of the upper shaft seat,
a bottom of the spring groove penetrates a bottom surface of the hinge seat;
a bottom end of the upper rotating shaft is extended downward into the spring groove, and a spring base with an outer edge that closes a bottom opening of the spring groove is provided on the bottom end of the upper rotating shaft through screws;
a push spring that is sleeved onto the bottom end of the upper rotating shaft is provided between the spring base and a top inner wall of the spring groove.

9. The double locked safety door barrier according to claim 2, wherein one end of the pressing plate away from the hinged side is provided with a first hook that is clamped on an inner edge of a top opening of the upper button slot,
the first hook prevents one end of the pressing plate away from the hinged side from disengaging from the upper button slot;
front and rear ends of the lower unlocking component are respectively provided with a second hook that prevents the lower unlocking component from disengaging from the lower button slot.

10. The double locked safety door barrier according to claim 4, wherein the upper locking tongue comprises an upper locking tongue shell;
a telescopic groove is provided in the upper locking tongue shell;
a front end of the telescopic groove penetrates a front side of the upper locking tongue shell,
a locking bolt that slides back and forth in the telescopic groove is provided in the telescopic groove;
a fourth reset member is provided between a tail end of the locking bolt and an inner wall of a tail end of the telescopic groove;
an anti-detachment groove is provided at a top of the telescopic groove;
a top of the locking bolt is provided with an anti-detachment clamp block that is inserted into the anti-detachment groove and moves back and forth in the anti-detachment groove;
squeezing grooves are respectively provided on outer walls of left and right sides of the upper locking tongue shell,
the pressing slope is provided on a wall surface facing a rear side of the squeezing grooves,
the avoidance grooves are respectively provided on left and right outer walls of the upper locking tongue shell behind the squeezing grooves;
the first reset member is provided in a center of a rear wall surface of the upper locking tongue shell.

11. The double locked safety door barrier according to claim 4, wherein the upper locking tongue comprises an upper locking tongue shell,
the upper locking tongue shell is provided with a telescopic groove,
a front end of the telescopic groove penetrates a front side of the upper locking tongue shell;
a locking bolt sleeve that is slid forward and backward in the telescopic groove is provided in the telescopic groove;
the locking bolt sleeve is provided with a magnetic locking bolt,
the upper locking buckle is embedded with a magnetic block configured for the magnetic locking bolt to be extended into the upper locking buckle,
a tail end of the locking bolt is provided with a protrusion with a diameter greater than that of the locking bolt,
the fourth reset member is provided at a head end of the locking bolt;
a tail end of the fourth reset member abuts against a protrusion;
a head end of the fourth reset member abuts against a front wall of an inner cavity of the locking bolt sleeve;
the anti-detachment groove is provided at a top of the telescopic groove, and the anti-detachment clamp block is inserted into the anti-detachment groove and moves back and forth in the anti-detachment groove is provided at a top of the locking bolt sleeve;
the pressing slopes are provided on left and right sides of the upper locking tongue shell;
the first reset member abuts against a center of a rear wall of the upper locking tongue shell.
